(19) United States
(12) Patent Application Publication
(10) Pub. No.: US 2025/0314544 A1
(43) Pub. Date: Oct. 9, 2025

(54) TACTILE SENSOR AND TACTILE SENSOR APPARATUS

(71) Applicant: Electronics and Telecommunications Research Institute, Daejeon (KR)

(72) Inventors: Jung Rak CHOI, Daejeon (KR); Hye Jin KIM, Daejeon (KR); Hun Pyo JU, Daejeon (KR); Han Bit JIN, Daejeon (KR)

(73) Assignee: Electronics and Telecommunications Research Institute, Daejeon (KR)

(21) Appl. No.: 19/038,818

(22) Filed: Jan. 28, 2025

(30) Foreign Application Priority Data
Apr. 5, 2024 (KR) 10-2024-0046825
Aug. 14, 2024 (KR) 10-2024-0109398

(51) Int. Cl. G01L 5/00; B25J 13/08; G01L 1/02

(52) U.S. Cl. CPC G01L 5/0061; B25J 13/084; G01L 1/02

(57) ABSTRACT

The present invention relates to a tactile sensor apparatus including a tactile sensor using an air pressure detecting method through an air chamber, a processor that detects a pressure level based on a degree of deformation of a membrane according to an internal pressure change of the air chamber of the tactile sensor, and a communication module that transmits the pressure level to a central processing device of a robot.

### CROSS-REFERENCE TO RELATED APPLICATION

This application claims priorities to and the benefits of Korean Patent Applications No. 10-2024-0046825 filed on Apr. 5, 2024 and No. 10-2024-0109398 filed on Aug. 14, 2024, the disclosure of which is incorporated herein by reference in its entirety.

### BACKGROUND

### 1. Field of the Invention

The present invention relates a tactile sensor and a tactile sensor apparatus capable of improving tactile ability of a robot finger.

### 2. Discussion of Related Art

In the field of robotics, the development of a robot hand, especially, tactile sensing abilities, has been continuously conducted with technological advances.

A main purpose of the robot hand is to manipulate various objects and interact with various environments.

For the manipulation of objects and interaction with various environments using the robot hand, in the related art, technologies mainly for sensors for touch detection, sensors for pressure detection, and some sensors for location detection have been applied and developed, and a robot hand technology to which a sensor is applied is developed mainly in two methods.

FIG. 1 is an exemplary view for describing a sensor method applied to a robot hand according to the related art.

FIG. 1A illustrates a robot finger to which a method of detecting a direct touch and pressure by arranging a force sensor at an end of the finger is applied, and FIG. 1B illustrates a robot finger to which a method of measuring a force and a torque generated by movement of the finger and a wrist by arranging a six-axis force/torque sensor at a joint is applied.

However, these sensor application methods according to the related art have the following limitations.

First, sensors located at the end of the finger may considerably precisely detect a pressure at a touch point but have a limitation in complex manipulation throughout the entire finger or in identifying overall force distribution of an object. To overcome this limitation, a larger number of sensor arrays are required, and it is also quite difficult to apply these sensors to the finger in the form of three dimensions.

Recently, a technology of attaching a tactile sensor array in the form of an artificial skin to a free shape such as a robot finger has been developed, but there is a disadvantage in that sensor pixels cannot detect a direction of a pressure applied to a skin surface, and thus an error occurs in a detection signal.

To overcome this disadvantage, a method of tracking the direction of the applied pressure by monitoring a pressure distribution of a pressure sensor array has been proposed, but this method may be applied only when a pressure is applied in a considerably wider range than the sensor pixel, and pressure level information collected from the sensor pixel is less accurate.

Further, the method of measuring the force and the torque generated by the movement of the finger and the wrist using the six-axis force/torque sensor disposed at the joint is useful in detecting overall changes in the force and the torque generated by the movement of a robot hand and a robot arm, but is difficult to precisely detect fine contact, force measurement in various directions, and delicate manipulation.

Accordingly, a technology for improving tactile ability of the robot finger by accurately measuring a pressure applied in various directions (i.e., in all directions of 360 degrees) across all the fingers of the robot hand is required in order to perform more delicate and precise works in complex and various environments using the robot hand.

The background art of the present invention is disclosed in Korean Patent Registration No. 10-2614186 (registered on Dec. 12, 2023).

### SUMMARY OF THE INVENTION

The present invention is directed to providing a tactile sensor and a tactile sensor apparatus capable of improving tactile ability of a robot finger.

According to an aspect of the present invention, a tactile sensor includes a hemispherical elastic member, a circuit board to which an opening of the hemispherical elastic member is attached, and a membrane formed on a surface of the circuit board, which corresponds to the opening of the hemispherical elastic member.

The membrane may detect an air pressure corresponding to an external force by detecting that the air pressure of an air chamber is changed as a shape of the elastic member is deformed and a bending shape is deformed by the changed air pressure when the external force is applied to the hemispherical elastic member.

When the opening of the hemispherical elastic member is attached to the circuit board, an interior of the hemispherical elastic member may be sealed so as to form an air chamber between the elastic member and the circuit board.

The air chamber may be formed as one air chamber or partitioned into a plurality of air chambers according to a shape of the elastic member.

When the air chamber is partitioned into a plurality of air chambers, the membrane may be formed on the surface of the circuit board, which corresponds to each of the plurality of air chambers.

The elastic member may include a translucent material or a transparent material.

The elastic member may be designed to have different thicknesses according to directions to adjust tactile sensing performance.

The elastic member may be designed to have different bending moduli according to portions to concentrate a pressure on a specific portion of the tactile sensor.

According to another aspect of the present invention, a tactile sensor apparatus includes a tactile sensor using an air pressure detecting method through an air chamber, a processor that detects a pressure level based on a degree of deformation of a membrane according to an internal pressure change of the air chamber of the tactile sensor, and a communication module that transmits the pressure level to a central processing device of a robot.

The tactile sensor apparatus may further include a display module that outputs light having a color corresponding to the pressure level detected through the tactile sensor.

The display module may include a light emitting element having a variable color.

The tactile sensor may output a pressure value as an absolute value regardless of a direction of a pressure applied to the tactile sensor.

The tactile sensor may include a hemispherical elastic member, a circuit board to which an opening of the hemispherical elastic member is attached, and a membrane formed on a surface of the circuit board, which corresponds to the opening of the hemispherical elastic member.

The membrane may detect an air pressure corresponding to an external force by detecting that the air pressure of an air chamber is changed as a shape of the elastic member is deformed and a bending shape is deformed by the changed air pressure when the external force is applied to the hemispherical elastic member.

When the opening of the hemispherical elastic member is attached to the circuit board, an interior of the hemispherical elastic member may be sealed so as to form an air chamber between the elastic member and the circuit board.

The air chamber may be formed as one air chamber or partitioned into a plurality of air chambers according to a shape of the elastic member.

When the air chamber is partitioned into a plurality of air chambers, the membrane may be formed on the surface of the circuit board, which corresponds to each of the plurality of air chambers.

The elastic member may include a translucent material or a transparent material.

The elastic member may be designed to have different thicknesses according to directions to adjust tactile sensing performance.

The elastic member may be designed to have different bending moduli according to portions to concentrate a pressure on a specific portion of the tactile sensor.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1A and 1B are exemplary views for describing a sensor method applied to a robot hand according to the related art;

FIG. 2 is a schematic exemplary view illustrating a configuration of a tactile sensor and a tactile sensor apparatus according to an embodiment of the present invention;

FIG. 3 is an exemplary view for describing a method of sensing a pressure by the tactile sensor in FIG. 2;

FIGS. 4A and 4B are exemplary views for describing a process of manufacturing an elastic member of the tactile sensor in a desired shape in FIG. 2;

FIGS. 5A and 5B are exemplary views for describing a shape of the elastic member that is designed according to tactile sensing performance in FIGS. 4A and 4B;

FIGS. 6A and 6B are exemplary views illustrating a tactile sensor system in which a tactile sensor is applied to each of robot fingers of a robot hand in FIG. 2;

FIGS. 7A to 7D are exemplary views illustrating a pressure signal that is detected when the tactile sensor of the tactile sensor apparatus is pressed in various pressures in FIG. 2;

FIGS. 8A to 8C are exemplary views for describing an operation of outputting a pressure level detected by the tactile sensor as visual information through a display module when an object is gripped using the robot hand to which the robot finger is coupled in FIGS. 6A and 6B; and

FIGS. 9A and 9B are exemplary views visually illustrating a gripping ability for various objects when an object is gripped using the robot hand to which the robot finger is coupled in FIGS. 6A and 6B.

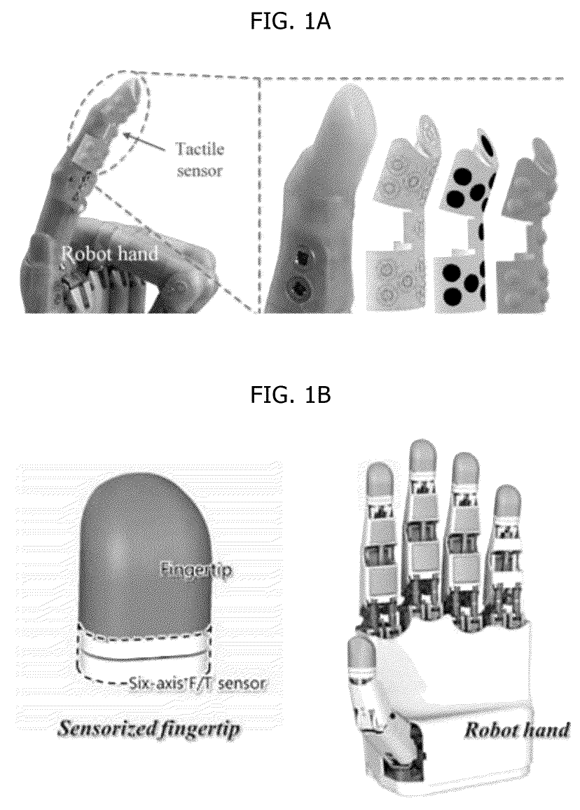

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, a tactile sensor and a tactile sensor apparatus according to embodiments of the present invention will be described.

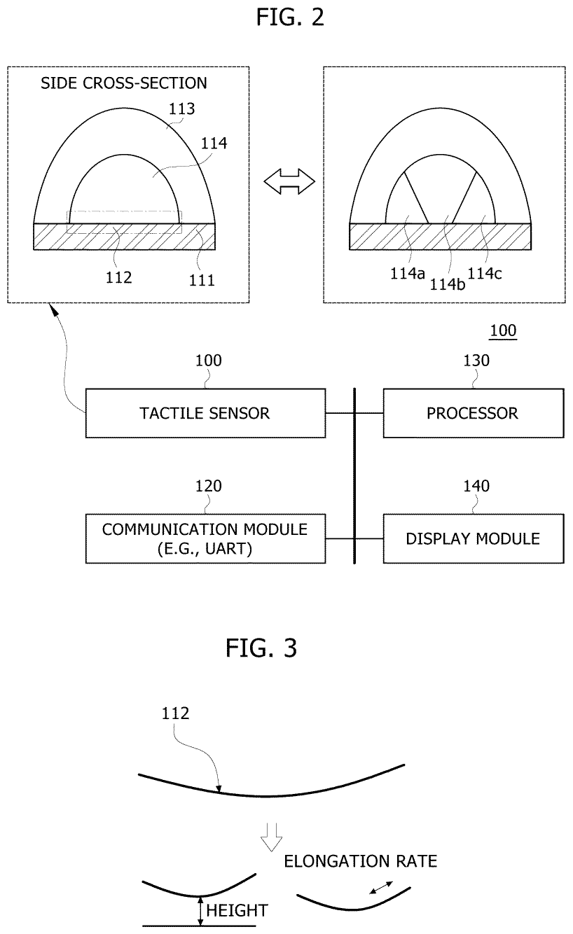

FIG. 2 is a schematic exemplary view illustrating a configuration of a tactile sensor and a tactile sensor apparatus according to an embodiment of the present invention.

Referring to FIG. 2, the tactile sensor apparatus 100 includes a tactile sensor 110, a communication module 120, a processor 130 (e.g., a micro controller unit (MCU)), and a display module 140.

The tactile sensor 110 includes a circuit board 111, a membrane 112, an elastic member 113, and an air chamber 114.

The tactile sensor apparatus 100 may be implemented on the circuit board 111.

The elastic member 113 is formed in a hemispherical shape (e.g., the form of a finger tip) and has a hemispherical opening attached (or bonded) to the circuit board 111.

When the opening of the hemispherical elastic member 113 is attached to the circuit board 111, an inside of the hemispherical elastic member 113 is sealed to form the air chamber 114.

When the opening of the hemispherical elastic member 113 is attached to the circuit board 111, the membrane 112 is formed on a surface (i.e., a surface in contact with the air chamber 114) of the circuit board 111 corresponding to the opening.

When an external force is applied to the hemispherical elastic member 113, an air pressure of the air chamber 114 is changed as the elastic member 113 is crushed according to a pressure corresponding to the external force, and a shape of the membrane 112 is deformed by the changed air pressure.

For example, a bending shape or a bending angle of the membrane 112 may be changed according to a change in the air pressure of the air chamber 114 (see FIG. 3).

The membrane 112 may be spaced apart upward from a surface of the circuit board 111 by a specified distance (see FIG. 3).

The air chamber 114 may be filled with air and sealed or a may be filled with specific gas and sealed. In the present embodiment, it is assumed that the air chamber 114 is filled with air and sealed.

In this case, the air sealed in the air chamber 114 is not a signal transmission means but corresponds to a kind of pressure generating means for generating the air pressure. That is, the air corresponds to an air pressure conversion means that converts an external force (external pressure) applied to the elastic member 113 into the air pressure.

The air chamber 114 may be partitioned into a plurality of air chambers 114a, 114b, and 114c according to the shape of the elastic member 113.

When the air chamber 114 is partitioned into the plurality of air chambers 114a, 114b, and 114c, the membrane 112 may be formed on the surface of the circuit board 111 (i.e., surfaces in contact with the plurality of air chambers 114a, 114b, and 114c) corresponding to the plurality of air chamber 114a, 114b, and 114c.

In this way, when the plurality of air chambers 114a, 114b, and 114c are formed and the membranes 112 corresponding thereto are formed, a multimodal tactile signal may be also detected.

The elastic member 113 may be formed of a translucent material or a transparent material.

The elastic member 113 may include a silicone material or a rubber material.

A specific color member (e.g., paint) may be printed or applied on the elastic member 113.

The processor 130 detects an internal pressure change (i.e., a pressure level) of the air chamber 114 of the tactile sensor 110 based on a degree of deformation of the membrane 112.

The processor 130 transmits the detected pressure level to a central processing unit of a robot (not illustrated) through the communication module 120.

The display module 140 outputs light having a color corresponding to the pressure level detected through the tactile sensor 110.

By visually displaying the pressure level detected through the tactile sensor 110 through the display module 140, intuitive feedback may be provided to a user and a researcher.

The display module 140 may include a light emitting element (e.g., a light emitting diode (LED)) of which a light color varies.

FIG. 3 is an exemplary view for describing a method of sensing a pressure by the tactile sensor in FIG. 2.

Referring to FIG. 3, the tactile sensor 110 may detect a pressure using the deformed shape of the membrane 112, for example, the tactile sensor 110 may measure a pressure value (or the pressure level) by converting physical deformation of the membrane 112 into an electrical signal using a capacitance measurement mechanism or a resistance measurement mechanism.

Further, based on this mechanism, the tactile sensor 110 may obtain a multimodal tactile signal through a single air chamber structure or a multiple-air chamber structure.

This multiplexed sensing system helps the robot finger, including the tactile sensor 110, more accurately recognize surface texture, hardness, and pressure distribution of a complex object, thereby enabling more complex work performance and more delicate grip manipulation.

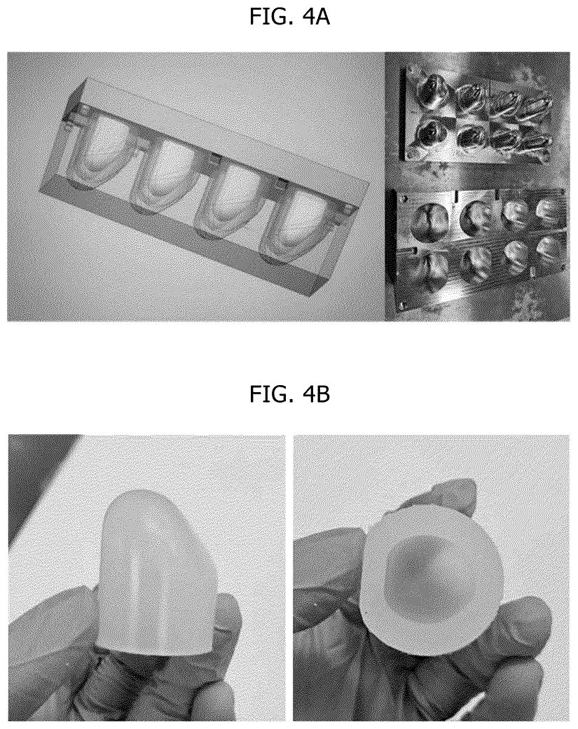

FIGS. 4A and 4B are exemplary views for describing a process of manufacturing an elastic member of the tactile sensor in a desired shape in FIG. 2.

As illustrated in FIG. 4A, a mold that may manufacture the elastic member 113 in a desired shape may be designed, and the liquified elastic member 113 is poured into the mold and cured. Thus, as illustrated in FIG. 4B, the elastic member 113 may be completely formed in a desired shape (e.g., a hemispherical shape and a finger tip shape).

In this case, the shape of the elastic member 113 may be designed or modified in various forms according to required tactile sensing performance (e.g., reactivity, sensitivity, precision, sensing range, or the like).

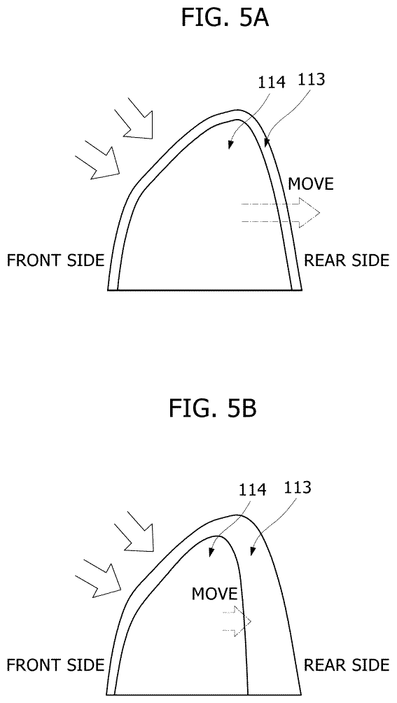

FIGS. 5A and 5B are exemplary views for describing a shape of the elastic member that is designed according to tactile sensing performance in FIGS. 4A and 4B.

Adjusting the tactile sensing performance (e.g., reactivity, sensitivity, precision, sensing range, or the like) of the tactile sensor 110 is an important factor when applied to various applications.

For example, a rear portion of the air chamber 114 is designed slightly thicker than a front portion thereof (i.e., thicknesses of the elastic member 113 in directions are differently designed), and thus when a pressure is applied from the front side, displacement of the tactile sensor may be reduced (i.e., deformation of the elastic member 113 may be reduced), and stability may be improved. This enables more accurate and consistent pressure detection in a process of manipulating various objects by the robot finger.

Further, the sensitivity of the tactile sensor can be precisely adjusted by adjusting a modulus of the elastic member 113 forming the air chamber 114.

Therefore, it is possible to prevent the tactile sensor 110 from reacting excessively sensitively and generating an error signal and to secure optimum tactile sensing performance (e.g., reactivity, sensitivity, precision, sensing range, and the like) suitable for a use environment.

Further, when the elastic member 113 is designed to increase a bending modulus, a pressure may be concentrated on a specific area of the tactile sensor 110, thereby allowing the robot finger to achieve high precision when finely manipulating an object or performing a specific work. That is, the elastic member 113 may be designed to have different bending moduli according to portions thereof to concentrate the pressure on a specific portion of the tactile sensor 110.

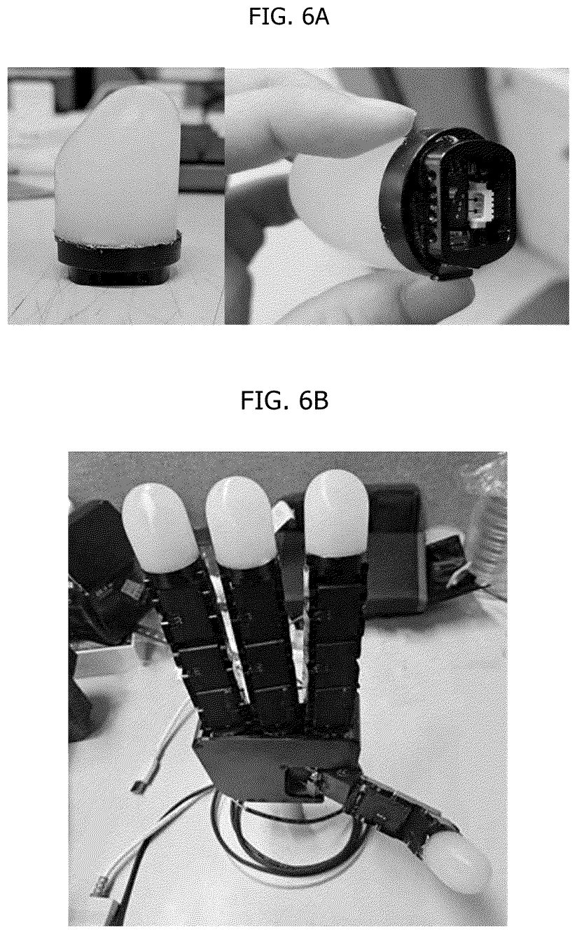

Hereinafter, FIGS. 6 to 9 are exemplary views illustrating an operation of testing performance by coupling the tactile sensor apparatus 100 according to the present embodiment to the robot finger.

FIGS. 6A and 6B are exemplary views illustrating a tactile sensor system in which a tactile sensor is applied to each of robot fingers of a robot hand in FIG. 2.

Referring to FIGS. 6A and 6B, the tactile sensor system couples the tactile sensor apparatus 100 including the tactile sensor 110 in which the elastic member 113 is formed in a finger shape (e.g., a finger tip shape) to each of the robot fingers of the robot hand.

FIG. 6A is an exemplary view illustrating an exterior shape of the tactile sensor apparatus 100 including the tactile sensor 110 in which the elastic member 113 is formed in the finger shape (e.g., the finger tip shape), and FIG. 6B is an exemplary view illustrating the robot hand in which the tactile sensor apparatus 100 is coupled to each of the robot fingers.

The robot finger, to which the tactile sensor apparatus 100 according to the present embodiment is coupled, may be integrated into the robot hand to communicate with a central system (not illustrated) of the robot hand and may perform natural hand and finger operation through precise control because a signal of the tactile sensor 110 is finely changed and transmitted according to rigidity of an object to be gripped.

For example, when the robot hand grips a heavy and hard object, the tactile sensor 110 detects a relatively high pressure level value, and in contrast, when the robot hand grips a light and soft object, the tactile sensor 110 detects a relatively low level pressure value.

In this case, when an object is gripped by the robot hand to which the plurality of robot fingers are coupled, a direction of a pressure applied to the tactile sensor 110 may be changed, but the pressure level indicated by each sensor is provided as an absolute value regardless of the direction of the pressure due to structural characteristics of the tactile sensor 110 including the air chamber 114.

Thus, the central system (not illustrated) of the robot hand may determine a force and a direction required to grip the object based on output values of the tactile sensors 110 and orientation values of the robot fingers, which are changed depending on a direction (e.g., a direction perpendicular or horizontal to the ground or a diagonal direction) in which the robot hand grips the object.

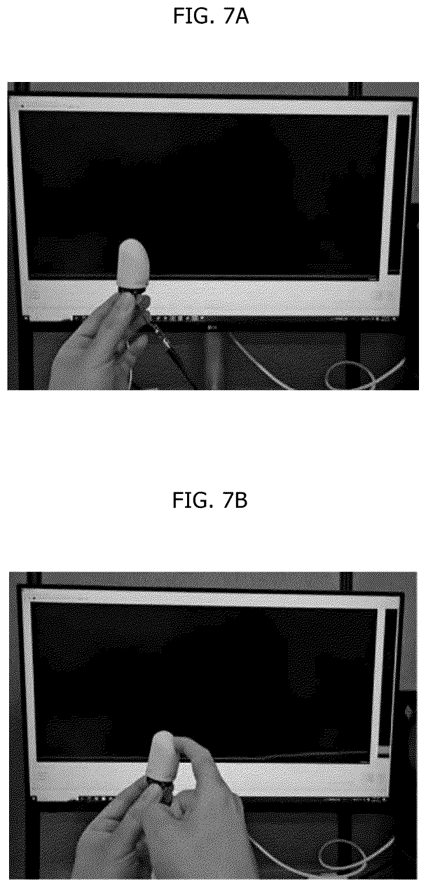

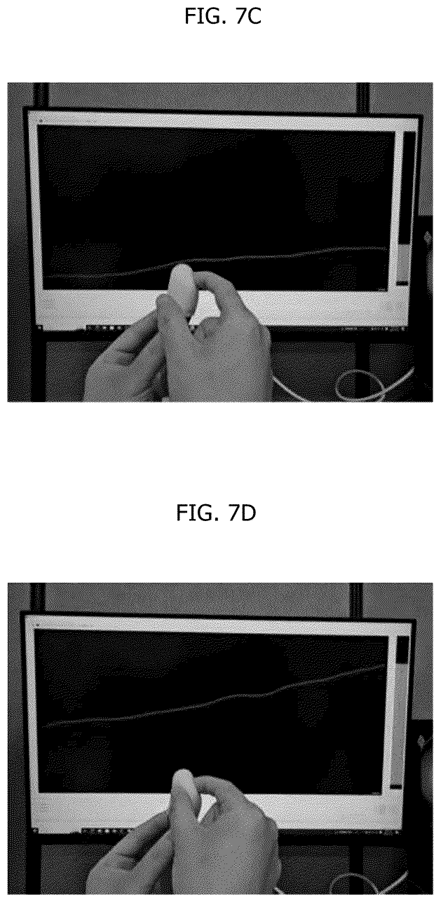

FIGS. 7A to 7D are exemplary views illustrating a pressure signal that is detected when the tactile sensor of the tactile sensor apparatus is pressed in various pressures in FIG. 2.

As illustrated in FIGS. 7A to 7D, it may be seen that, when the tactile sensor 110 of the tactile sensor apparatus 100 is pressed with a pressure that is gradually increased, a pressure signal output from the tactile sensor 110 in response thereto is also gradually increased as displayed on a screen.

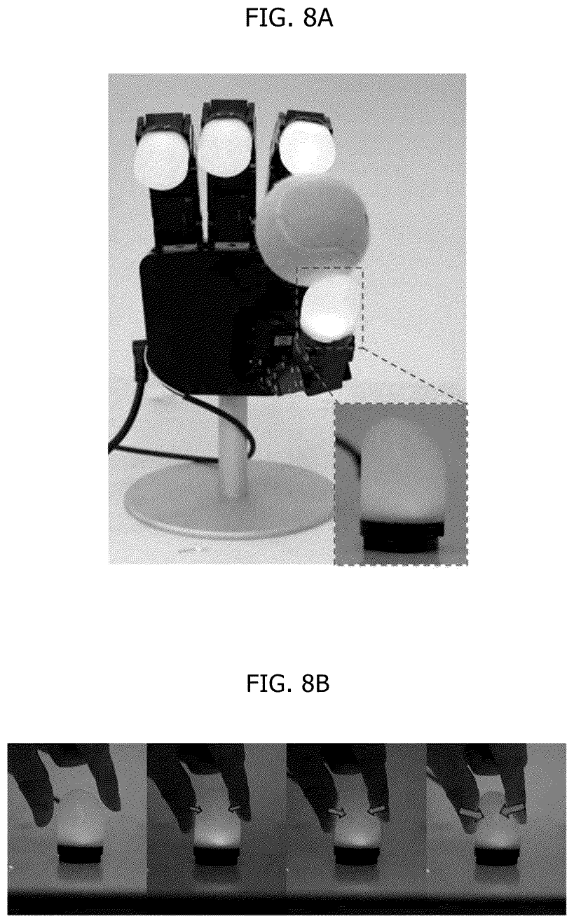

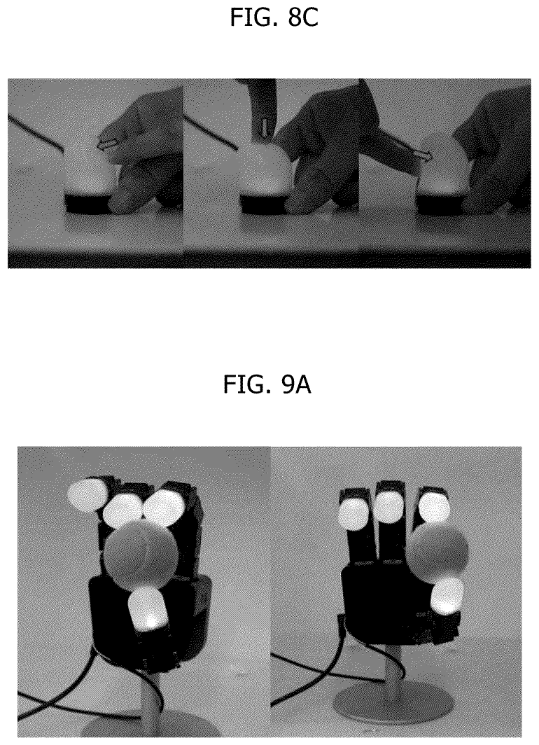

FIGS. 8A to 8C are exemplary views for describing an operation of outputting a pressure level detected by the tactile sensor as visual information through a display module when an object is gripped using the robot hand to which the robot finger is coupled in FIGS. 6A and 6B.

Referring to FIGS. 8A to 8C, it may be seen that, when a certain pressure is applied to the tactile sensor 110 in various directions, the tactile sensor apparatus 100 according to the present embodiment outputs an absolute pressure value without distortion regardless of a direction in which the pressure is applied. Further, it may be seen that even minute pressure changes may be precisely detected.

Referring to FIG. 8A, it may be seen that the robot finger gripping a ball and the robot finger not gripping a ball have a slight pressure difference in the tactile sensor 110, referring to FIG. 8B, it may be seen that a difference in the pressure applied to the tactile sensor 110 in the same direction may be detected, and referring to FIG. 8C, it may be seen that, when the same pressure is input to the tactile sensor 110 in various directions, the same pressure may be detected regardless of a direction in which the pressure is input.

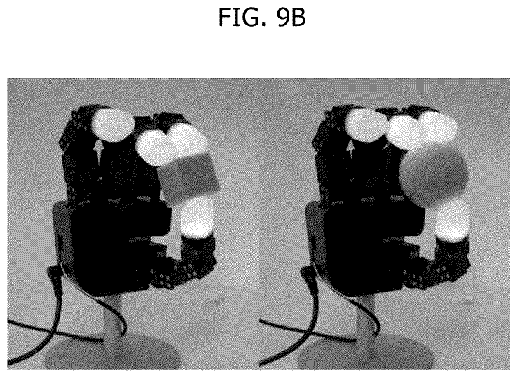

FIGS. 9A and 9B are exemplary views visually illustrating a gripping ability for various objects when an object is gripped using the robot hand to which the robot finger is coupled in FIGS. 6A and 6B.

Referring to FIG. 9A, the user (experimenter) may intuitively identify the pressure applied to each of the fingers by displaying the pressure level applied to each of the fingers as visual information (e.g., color) when the same object (e.g., a ball) is gripped with two fingers and three fingers.

Referring to FIG. 9B, the user (experimenter) may intuitively identify the pressure applied to each of the fingers by displaying the pressure level applied to each of the fingers as visual information (e.g., color) when different objects (e.g., a cube and a ball) are gripped with the same three fingers.

In this way, the tactile sensor apparatus 100 according to the present embodiment may indicate, through a color change of the display module 140, a degree of the pressure applied to each of the fingers when an object is gripped using the robot hand equipped with the robot fingers, and thus may intuitively identify how delicately the robot hand may adjust a force to grip the object.

The tactile sensor 110 according to the present embodiment may accurately detect the pressure applied in all directions of 360 degrees using the change in the air pressure in the air chamber and may detect an accurate and precise pressure level no matter which direction the object is gripped.

The tactile sensor apparatus 100 according to the present embodiment may improve tactile sensing performance by applying various shapes and mechanical modulus to the air chamber structure. Accordingly, the robot finger may more precisely and stably handle objects having various shapes and various sizes.

The tactile sensor apparatus 100 according to the present embodiment may be designed to prevent the sensor from being directly exposed to a portion to which an external pressure is applied. That is, the portion to which the external pressure is applied is the elastic member 113, and the membrane 112, which detects the air pressure charged according to the deformation of the elastic member 113, may be protected by the elastic member 113, and thus durability thereof may be improved, and long-term stable use thereof may be achieved.

The present embodiment may improve the tactile ability of the robot fingers, overcome limitations of the tactile sensing functions in the robot fingers according to the related art, and achieve flexibility and high tactile abilities similar to those of human hands, and may more delicately and precisely perform interactions with various objects through the robot fingers, thereby expanding the scope of work of the robot and improving efficiency thereof.

According to an aspect of the present invention, the present invention can improve tactile ability of a robot finger.

The present invention can overcome limitations of a tactile sensing function occurring in a robot finger according to the related art and achieve flexibility and high tactile abilities similar to those of a human hand.

The present invention can more delicately and precisely perform interactions with various objects through the robot finger, thereby expanding the scope of work of the robot and improving efficiency thereof.

What is claimed is:

1. A tactile sensor comprising:
a hemispherical elastic member;
a circuit board to which an opening of the hemispherical elastic member is attached; and
a membrane formed on a surface of the circuit board, which corresponds to the opening of the hemispherical elastic member.

2. The tactile sensor of claim 1, wherein the membrane detects an air pressure corresponding to an external force by detecting that the air pressure of an air chamber is changed as a shape of the elastic member is deformed and a bending shape of the membrane is deformed by the changed air pressure when the external force is applied to the hemispherical elastic member.

3. The tactile sensor of claim 1, wherein, when the opening of the hemispherical elastic member is attached to the circuit board, an interior of the hemispherical elastic member is sealed so as to form an air chamber between the elastic member and the circuit board.

4. The tactile sensor of claim 3, wherein the air chamber is formed as one air chamber or partitioned into a plurality of air chambers according to a shape of the elastic member.

5. The tactile sensor of claim 3, wherein, when the air chamber is partitioned into a plurality of air chambers, the membrane is formed on the surface of the circuit board, which corresponds to each of the plurality of air chambers.

6. The tactile sensor of claim 1, wherein the elastic member includes a translucent material or a transparent material.

7. The tactile sensor of claim 1, wherein the elastic member is designed to have different thicknesses according to directions to adjust tactile sensing performance.

8. The tactile sensor of claim 1, wherein the elastic member is designed to have different bending moduli according to portions to concentrate a pressure on a specific portion of the tactile sensor.

9. A tactile sensor apparatus comprising:
a tactile sensor using an air pressure detecting method through an air chamber;
a processor configured to detect a pressure level based on a degree of deformation of a membrane according to an internal pressure change of the air chamber of the tactile sensor; and
a communication module configured to transmit the pressure level to a central processing device of a robot.

10. The tactile sensor apparatus of claim 9, further comprising a display module configured to output light having a color corresponding to the pressure level detected through the tactile sensor.

11. The tactile sensor apparatus of claim 10, wherein the display module includes a light emitting element having a variable light color.

12. The tactile sensor apparatus of claim 9, wherein the tactile sensor outputs a pressure value as an absolute value regardless of a direction of a pressure applied to the tactile sensor.

13. The tactile sensor apparatus of claim 9, wherein the tactile sensor includes:
a hemispherical elastic member;
a circuit board to which an opening of the hemispherical elastic member is attached; and
a membrane formed on a surface of the circuit board, which corresponds to the opening of the hemispherical elastic member.

14. The tactile sensor apparatus of claim 13, wherein the membrane detects an air pressure corresponding to an external force by detecting that the air pressure of an air chamber is changed as a shape of the elastic member is deformed and a bending shape of the membrane is deformed by the changed air pressure when the external force is applied to the hemispherical elastic member.

15. The tactile sensor apparatus of claim 13, wherein, when the opening of the hemispherical elastic member is attached to the circuit board, an interior of the hemispherical elastic member is sealed so as to form an air chamber between the elastic member and the circuit board.

16. The tactile sensor apparatus of claim 15, wherein the air chamber is formed as one air chamber or partitioned into a plurality of air chambers according to a shape of the elastic member.

17. The tactile sensor apparatus of claim 15, wherein, when the air chamber is partitioned into a plurality of air chambers, the membrane is formed on the surface of the circuit board, which corresponds to each of the plurality of air chambers.

18. The tactile sensor apparatus of claim 13, wherein the elastic member includes a translucent material or a transparent material.

19. The tactile sensor apparatus of claim 13, wherein the elastic member is designed to have different thicknesses according to directions to adjust tactile sensing performance.

20. The tactile sensor apparatus of claim 13, wherein the elastic member is designed to have different bending moduli according to portions to concentrate a pressure on a specific portion of the tactile sensor.
